(19) United States
(12) Patent Application Publication
(10) Pub. No.: US 2014/0097970 A1
(43) Pub. Date: Apr. 10, 2014

(54) Multi-Function Traffic Control Device for Flaggers

(71) Applicant: Lawrence Price Ethington, Yuba City, CA (US)

(72) Inventor: Lawrence Price Ethington, Yuba City, CA (US)

(21) Appl. No.: 13/645,312

(22) Filed: Oct. 4, 2012

(51) Int. Cl. G08G 1/0955

(52) U.S. Cl. CPC G08G 1/0955
USPC 340/908

(57) ABSTRACT

A traffic control device which incorporates multiple safety features that are needed by a traffic control flagger into one simple device, thus making their job less distracting, complicated, and safer for the flagger and the associated traffic.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD

The Present invention relates to the Technical Field of traffic control devices for use by traffic control flaggers. More particularly, the present invention relates to multi-functional traffic control devices that incorporate typical traffic paddle signs, rechargeable RED and YELLOW flashing lights, audible sound alarms, and 2-Way communications into a single lightweight flagger pole assembly.

### BACKGROUND OF THE INVENTION

There are currently a wide variety of traffic control devices in use for traffic control flaggers. Some examples are illuminated reflective paddle signs, flashing lights associated in various ways to STOP/SLOW signage, removable and configurable flashers that attach to existing signage, and many other types and configurations. The traffic control industry is regulated by various State and Federal Guidelines and Regulations that dictate such things as flasher lighting color, flasher intensity, size of signage text, viewing height of the sign, and various other things that relate to general and specific flagger and traffic safety concerns. The present invention works in conjunction with all these regulations and does not require any modifications or changes to current regulation in order to be used in its various environments and uses.

The present invention is a single lightweight flagger pole that has rechargeable battery powered RED and YELLOW flasher lights on opposite sides incorporated into a housing mounted at the top of the pole with a socket in the top of the housing for a standard reflective or illuminated STOP/SLOW paddle to be mounted into, a built-in or mounting feature for a 2-Way communication device, and an audible sound alarm. The effect of this invention is to provide the traffic control flagger with a single traffic control device that has all of the tools required to do his job safely, incorporated into one easy-to-use flagger pole assembly.

### DISCLOSURE OF INVENTION

The present invention is in the technical field of traffic control devices. More particularly, the present invention is in the technical field of traffic control devices used by traffic control flaggers. Specifically, it is a flagger pole assembly that incorporates a lightweight pole, a typical STOP/SLOW paddle sign, colored flashers, an audible alarm, and a 2-Way radio communication device into one simple pole assembly.

The very nature of the job of a traffic control flagger is dangerous and requires the flagger to keep track of various things at once. Since the flagger has no control over the oncoming traffic he relies heavily on signage, and attention getting devices to get the attention of the drivers that are approaching. Often flaggers find themselves in unexpected circumstances due to the random and unpredictable actions of vehicle drivers and the fact that they constantly have to coordinate efforts with the flagger on the opposite end of the construction area. Often the flagger has to hold the signs, visually keep track of traffic on his end of the construction site, and talk on handheld radios with the flagger on the other end of the construction site to coordinate traffic flow. All these factors make for a complicated situation and create potential for something to be missed and therefore a greater chance for mistakes. All these things highlight the need for the present invention in that it incorporates all aspects of the flagger's job into one device that he can easily be handled with one hand.

The present invention encompasses a flagger pole with a housing structure mounted on the top of the pole with a RED flasher on one side and a YELLOW flasher on the other with independent switch controls. Additionally there is a paddle sign socket on the top of the housing that that can have a STOP/SLOW paddle sign mounted into it. There is also a 2-Way radio built into the device that has simple push to talk controls and a high decibel sound alarm with a simple push button operation. The device is battery operated and is rechargeable. The device is lightweight and easy to handle in case the flagger has to move out of the way of oncoming traffic and shock resistant in case it is impacted by a vehicle or is dropped.

The effect of the present invention is a device that simplifies all the tasks of the flagger into one easy to use device and allows the operator to be less distracted and better able to pay attention to the unpredictable dangers of the job. The present invention creates a safer work environment for the flagger by taking away the complexity of the job due to having to handle multiple devices at once. The present invention is not a specific device of specified construction but rather any conceived device that incorporates all or multiples of said features into one.

### BRIEF DESCRIPTION OF THE DRAWINGS

FIG. 1 is a Front view of the Multi-Function Traffic Control Device for Flaggers illustrating all the general features of the invention.

FIG. 2 is a Front view of the Multi-Function Traffic Control Device for Flaggers illustrating the RED Flasher light and STOP side of the paddle sign.

FIG. 3 is a Rear view of the Multi-Function Traffic Control Device for Flaggers illustrating the YELLOW Flasher light and SLOW side of the hand paddle sign and the independent flasher switches.

FIG. 4 is a Side view of the housing of the Multi-Function Traffic Control Device for Flaggers illustrating the 2-Way Radio, a push to talk button, and the audible alarm features of the present invention.

### BEST MODE OF CARRYING OUT THE INVENTION

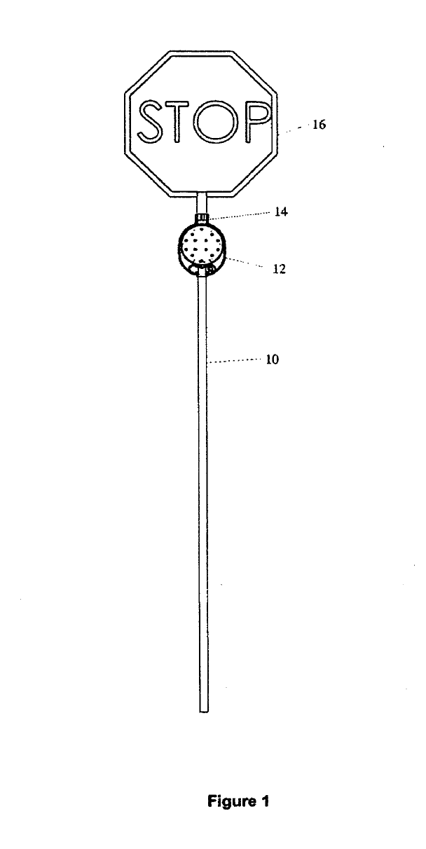

Referring now to the invention in more detail, in FIG. 1, is a Front view of the Multi-Function Traffic Control Device for flaggers illustrating its light weight pole assembly 10 along with the Flasher and control Housing 12. Additionally depicted are the paddle sign socket 14 and the paddle sign 16. The present invention is battery operated and can utilizes lightweight rechargeable batteries housed inside the control housing as the overall ergonomics of the device require that the control housing and the components are well balanced with the lower porting of the pole.

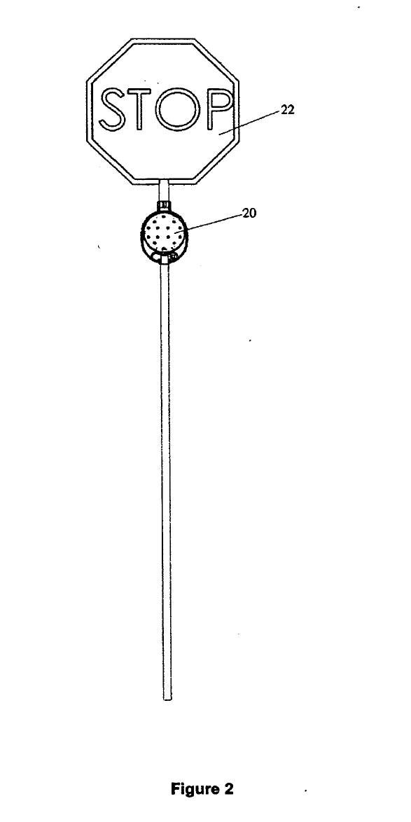

Referring now to the invention in more detail, in FIG. 2, illustrates the Front view of the present invention with the RED flasher light 20 and the STOP side of the paddle sign 22.

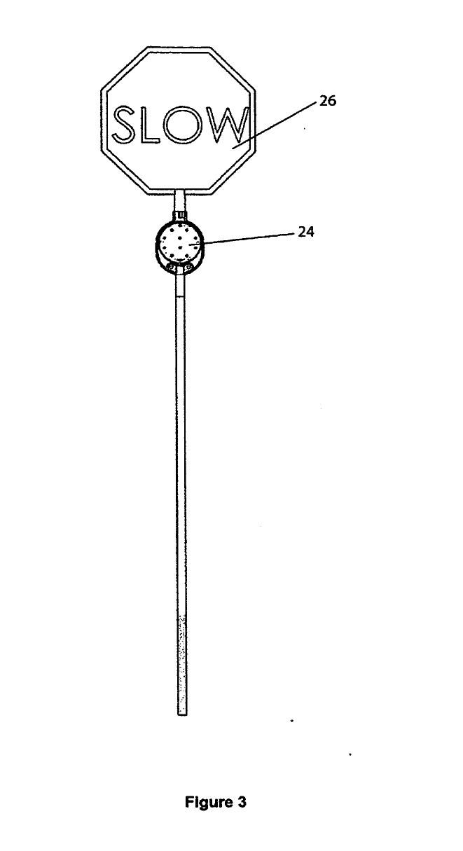

Referring now to the invention in more detail, in FIG. 3, illustrates the Rear view of the present invention with the YELLOW flasher light 24 and the SLOW side of the paddle sign 26.

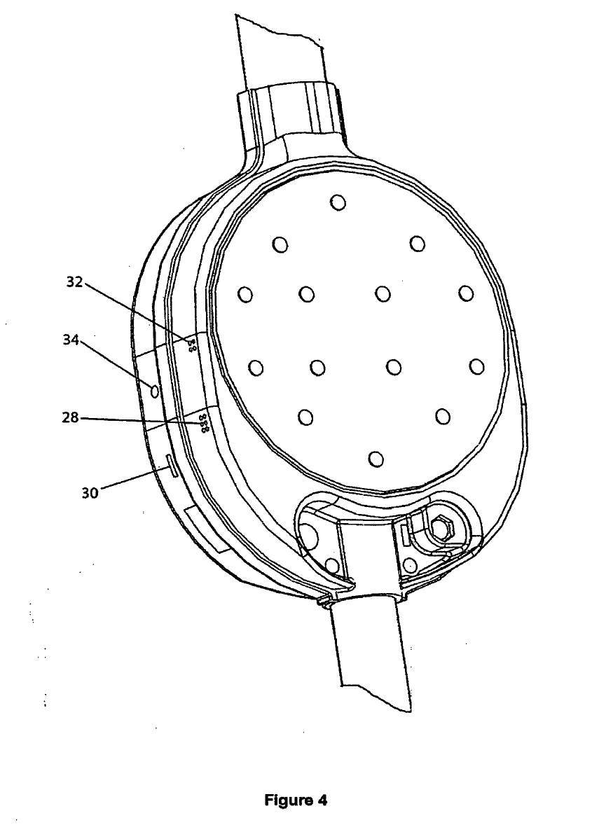

Referring now to the invention in more detail, in FIG. 4, illustrates the Side view of the control housing of the present invention depicting the built-in 2-Way radio speaker 28 with push to talk button 30 and the sound alarm speaker 32 and activation button 34. The 2-Way radio system could also be stand alone and attach to the housing via a bracket assembly as another possible configuration.

The Construction details of the present invention as shown in FIG. 1-4 are a lightweight pole constructed of lightweight metal, plastic, or other lightweight materials with a small lightweight molded plastic housing at the top of the pole. Mounted inside the housing are the RED and YELLOW flasher lights on the front and back with independent flasher switches on each side. Additionally, mounted inside the housing on the side are the 2-Way radio components and the sound alarm components. All component switches and buttons are simple to actuate and are designed to be weatherproof and impact resistant. In the top of the housing is a socket that receives the standard STOP/SLOW paddle sign handle allowing the sign to be manually turned as the pole is rotated manually from RED to YELLOW flasher light sides of the housing.

The Advantages of the present invention include, without limitation, a light weight, one piece traffic control device that incorporates all of the tools of a traffic control flagger's job into one simple device. Additionally, the reduction in the number of individual devices needed to accomplish the job make the flagger able to stay more focused on the dangers of unpredictable drivers and makes him more able to avoid accidents and maintain a safer environment overall.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. A multi-functional traffic control device incorporating a lightweight pole, a control housing with rechargeable RED and YELLOW flasher lights on opposite sides, a socket for a standard STOP/SLOW paddle at the top, a built in audible alarm, and a built in two-way radio in a single easy to use device.

2. The multi-functional traffic control device according to claim 1 wherein said STOP/SLOW paddle sign handle fits into the top to the pole which is slotted to receive the paddle sign so that it cannot twist or easily fall out.

3. The multi-functional traffic control device according to claim 1 wherein said RED and YELLOW flasher lights are mounted in a lightweight housing on opposite sides corresponding to said STOP/SLOW sides of the paddle sign.

4. The multi-functional traffic control device according to claim 1 wherein said RED and YELLOW flasher lights have multi functionality for easy transition between standard luminance to higher luminance, standard flashing sequence to a “Panic” rapid flashing sequence.

5. The multi-functional traffic control device according to Claim I wherein the said audible alarm is built into the said housing with a switch or button that initiates a high pitched warning alarm.

6. The multi-functional traffic control device according to claim 1 wherein said two-way radio receiver and transmitter is built into the said housing for communications between the two flagging locations.

7. The multi-functional traffic control device according to claim 1 wherein said housing has a clip feature for holding an external two-way radio.
